(19) United States
(12) Patent Application Publication
(10) Pub. No.: US 2019/0059675 A1
(43) Pub. Date: Feb. 28, 2019

(54) VACUUM CLEANER

(71) Applicant: ZENG HSING INDUSTRIAL CO., LTD., Taichung City (TW)

(72) Inventor: Shang-Heng LEE, Taichung City (TW)

(73) Assignee: ZENG HSING INDUSTRIAL CO., LTD., Taichung City (TW)

(21) Appl. No.: 15/689,112

(22) Filed: Aug. 29, 2017

(51) Int. Cl. A47L 9/28; A47L 5/12; H02J 7/00

(52) U.S. Cl. CPC A47L 9/2878; A47L 9/2884; H01M 2/10; A47L 5/12; H02J 7/0003; A47L 9/2842

(57) ABSTRACT

A vacuum cleaner includes a motor and an alternating current to direct current (AC-to-DC) converting unit including first and second power supplies, a DC stabilizer and a rechargeable battery. The first and second power supplies respectively convert mains electricity from a power socket into first and second DC electricity. The DC stabilizer stabilizes the first DC electricity to output stabilized DC electricity to the motor. The rechargeable battery is to be charged by the second DC electricity. When the vacuum cleaner is turned on and mains electricity is provided to the AC-to-DC converting unit, the vacuum cleaner operates in an external power supply mode, in which the first and second power supplies are activated to respectively drive the motor and charge the rechargeable battery.

### FIELD

The disclosure relates to a vacuum cleaner to be powered by different power sources.

### BACKGROUND

A conventional vacuum cleaner is usually powered by mains electricity through electrical connection between a power plug of the conventional vacuum cleaner and a power socket. A conventional cordless vacuum cleaner is usually driven by a motor that has a relatively low output power which adversely affects vacuuming performance of the cordless vacuum cleaner.

### SUMMARY

Therefore, an object of the present disclosure is to provide a vacuum cleaner capable of being driven by different power sources and including a motor that provides a relatively high output power.

According to one aspect of the present disclosure, a vacuum cleaner includes a motor, an alternating current to direct current (AC-to-DC) converting unit, an operating unit and a control unit. The motor is configured to be driven by direct current (DC) electricity and has an output power not less than 350 watts. The AC-to-DC converting unit includes a first power supply, a DC stabilizer, a second power supply and a rechargeable battery. The first power supply is configured to be electrically connected to a power socket to receive mains electricity and is configured to convert mains electricity into first DC electricity. The DC stabilizer is electrically connected to the first power supply and the motor, and is configured to stabilize the first DC electricity received from the first power supply so as to output stabilized DC electricity with a current value that is maintained at a level not larger than 20 amperes to the motor. The second power supply is configured to be electrically connected to the power socket to receive mains electricity, and is configured to convert mains electricity into second DC electricity. The rechargeable battery is electrically connected to the second power supply and the motor, and is configured to be charged by the second DC electricity received from the second power supply. The operating unit includes a switch for turning on the vacuum cleaner. The control unit is electrically connected to the first power supply, the second power supply and the switch. When the switch is in a conductive state and the control unit detects that the power socket provides mains electricity to the first and second power supplies, the vacuum cleaner operates in an external power supply mode. In the external power supply mode, the control unit activates the first power supply to convert mains electricity into the first DC electricity so that the DC stabilizer outputs the stabilized DC electricity to the motor, and activates the second power supply to convert mains electricity into the second DC electricity so that the rechargeable battery is charged by the second DC electricity.

### BRIEF DESCRIPTION OF THE DRAWINGS

Other features and advantages of the present disclosure will become apparent in the following detailed description of the embodiment with reference to the accompanying drawings, of which:

FIG. 1 is a schematic perspective diagram of a vacuum cleaner according to an embodiment of the present disclosure; and

FIG. 2 is a schematic block diagram of the vacuum cleaner.

### DETAILED DESCRIPTION

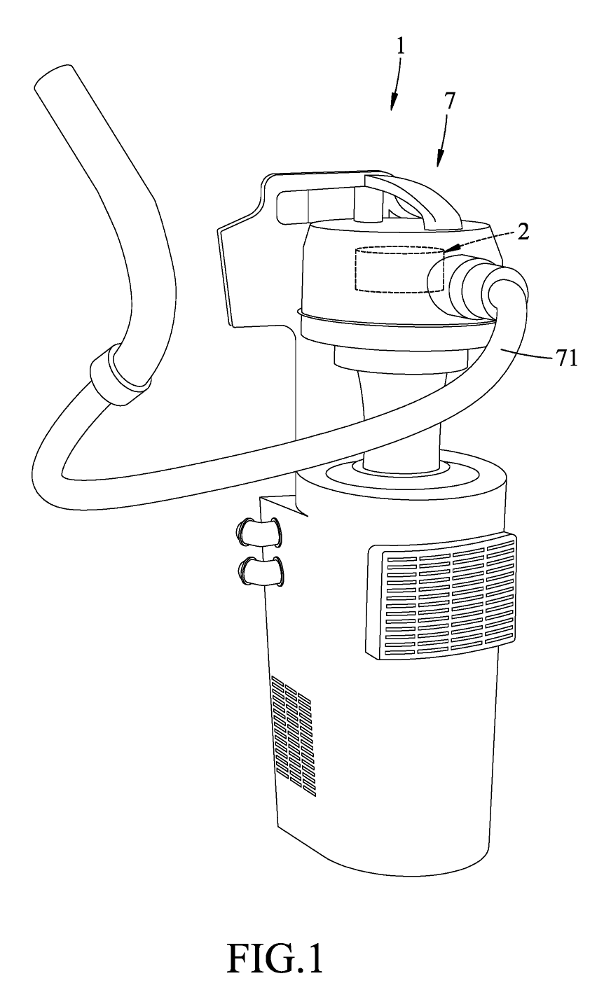

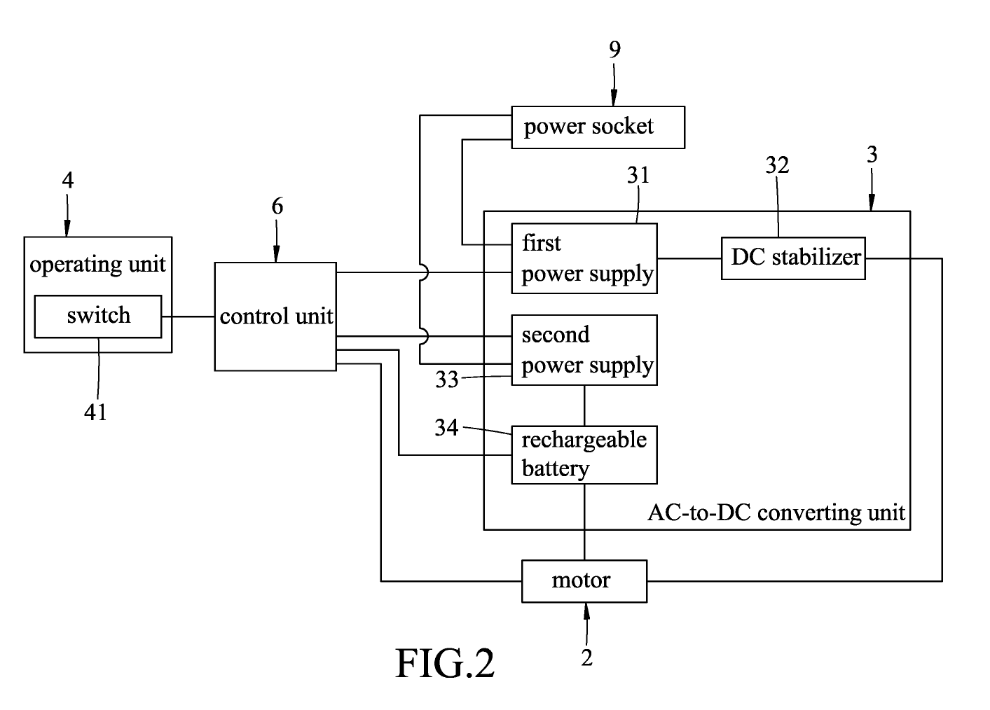

Referring to FIGS. 1 and 2, a vacuum cleaner 1 according to an embodiment of this disclosure is shown. The vacuum cleaner 1 includes a motor 2, an alternating current to direct current (AC-to-DC) converting unit 3, an operating unit 4, a control unit 6, a housing 7 and a tube 71. The motor 2 is to be driven by direct current (DC) electricity and has an output power not less than 350 watts. In this embodiment, the motor 2 is driven by DC electricity with a voltage value of 24 volts. The housing 7 contains the motor 2 therein. The tube 71 is in fluid communication with an opening formed in the housing 7, and corresponds in position to the motor 2 for vacuuming up dust and dirt.

The AC-to-DC converting unit 3 includes a first power supply 31, a DC stabilizer 32, a second power supply 33 and a rechargeable battery 34. In this embodiment, the first and second power supplies 31 and 33 are electrically connected to a power socket 9 (e.g., household electrical outlet) through a power plug (not shown) when the power plug is plugged into the power socket 9. The first power supply 31 is configured to convert mains electricity from the power socket 9 into first DC electricity. In one embodiment, the first power supply 31 outputs the first DC electricity with a voltage value of 24 volts. The DC stabilizer 32 is electrically connected to the first power supply 31 and the motor 2, and is configured to stabilize the first DC electricity received from the first power supply 31 so as to output stabilized DC electricity. In one embodiment, the DC stabilizer 32 outputs the stabilized DC electricity with a current value that is maintained at a level not larger than 20 amperes to the motor 2. The second power supply 33 is configured to convert mains electricity into second DC electricity. In one embodiment, the second power supply 33 outputs the second DC electricity with a voltage value ranging from 27 volts to 28 volts and a current value of 3 amperes. Note that, in this embodiment, the first and second power supplies 31, 33 are commercially available AC-to-DC power supplies provided with the function of electric power conversion, and the DC stabilizer 32 includes a current stabilizing circuit and the present disclosure is not limited in this aspect.

The rechargeable battery 34 is electrically connected to the second power supply 33 and the motor 2, and is to be charged by the second DC electricity received from the second power supply 33. The rechargeable battery 34 has a relatively large capacity, e.g. , larger than 6000 mAh (milli Ampere-hour) . In this embodiment, the rechargeable battery 34 has a capacity of 8700 mAh.

The operating unit 4 includes a switch 41 for turning on the vacuum cleaner 1. In one embodiment, the operating unit 4 is a user interface accessible and operable by a user of the vacuum cleaner 1 and the switch 41 is a power switch for turning the vacuum cleaner 1 on or off. The control unit 6 is electrically connected to the motor 2, the first power supply 31, the second power supply 33, the rechargeable battery 34 and the switch 41.

When the switch 41 is in a conductive state for turning on the vacuum cleaner 1 and the control unit 6 detects that the power socket 9 provides mains electricity to the first and second power supplies 31 and 33, the vacuum cleaner 1 operates in an external power supply mode. In the external power supply mode, the control unit 6 activates the first power supply 31 to convert mains electricity into the first DC electricity so that the DC stabilizer 32 outputs the stabilized DC electricity to the motor 2, deactivates the second power supply 33 for a predetermined time period and activates the second power supply 33 to convert mains electricity into the second DC electricity for charging of the rechargeable battery 34 upon elapsing of the predetermined time period. That is to say, in the external power supply mode, the motor 2 is powered up by the stabilized DC electricity converted from mains electricity and the rechargeable battery 34 is charged by the second DC electricity, which is also converted from mains electricity, at the same time. The predetermined time period is one second in this embodiment. However, the predetermined time period can be varied to any time period greater than zero seconds and implementation of the same is not limited to the disclosure herein. Note that by virtue of the DC stabilizer 32 that outputs the stabilized DC electricity with the current value not larger than 20 amperes to the motor 2, the motor 2 would not be damaged by inrush current as the vacuum cleaner 1 is powered up. Further, damage to the rechargeable battery 34 due to surge voltage resulting from abrupt input of mains electricity to the second power supply 33 can also be prevented since activation of the second power supply 33 is delayed for one second when the control unit 6 detects that the power socket 9 provides mains electricity to the second power supply 33. The control unit 6 is a processor in this embodiment and the present disclosure is not limited in this aspect.

When the switch 41 is in the conductive state for turning on the vacuum cleaner 1 and the control unit 6 detects that no mains electricity is provided to the first and second power supplies 31 and 33, the vacuum cleaner 1 operates in a battery-powered mode. In the battery-powered mode, the control unit 6 controls the rechargeable battery 34 to provide electricity to the motor 2. It should be noted that in the battery-powered mode, the motor 2 also has an output power not less than 350 watts.

When the switch 41 is in a non-conductive state for turning off the vacuum cleaner 1 and the control unit detects that the power socket 9 provides mains electricity to at least the second power supply 33, the vacuum cleaner 1 operates in a battery-charging mode. In this embodiment, in the battery-charging mode, the power socket 9 provides mains electricity to both of the first and second power supplies 31 and 33. In the battery-charging mode, the control unit 6 similarly deactivates the second power supply 33 for the predetermined time period, i.e., one second, and activates the second power supply 33 to convert mains electricity into the second DC electricity for charging the rechargeable battery 34 upon elapsing of the predetermined time period. At this time, the motor 2 is controlled by the control unit 6 to refrain from operation, and the rechargeable battery 34 is charged by the second DC electricity.

To sum up, by virtue of the first and second power supplies 31 and 33, the DC stabilizer 32, the control unit 6 and the rechargeable battery 34, the vacuum cleaner 1 of this disclosure can operate in three modes, i.e., the external power supply mode, the battery-powered mode and the battery-charging mode, based on whether mains electricity is provided to the first and second power supplies 31 and 33, and whether the switch 41 is in the conductive state or the non-conductive state. In the external power supply mode, the motor 2 has a relatively large output power not less than 350 watts. Meanwhile, since the stabilized DC electricity output by the DC stabilizer 32 to the motor 2 has a current value not larger than 20 amperes, damage to the motor 2 by inrush current caused at the moment when the vacuum cleaner 1 is powered up can be prevented. In the battery-powered mode, since the rechargeable battery 34 has a relatively large capacity, e.g., 8700 mAh, the motor 2 that is driven by the rechargeable battery 34 also has an output power not less than 350 watts and thus provides a relatively good vacuuming performance to the vacuum cleaner 1.

In the description above, for the purposes of explanation, numerous specific details have been set forth in order to provide a thorough understanding of the embodiment. It will be apparent, however, to one skilled in the art, that one or more other embodiments may be practiced without some of these specific details. It should also be appreciated that reference throughout this specification to “one embodiment,” “an embodiment,” an embodiment with an indication of an ordinal number and so forth means that a particular feature, structure, or characteristic may be included in the practice of the disclosure. It should be further appreciated that in the description, various features are sometimes grouped together in a single embodiment, figure, or description thereof for the purpose of streamlining the disclosure and aiding in the understanding of various inventive aspects.

While the disclosure has been described in connection with what is considered the exemplary embodiment, it is understood that this disclosure is not limited to the disclosed embodiment but is intended to cover various arrangements included within the spirit and scope of the broadest interpretation so as to encompass all such modifications and equivalent arrangements.

What is claimed is:

1. A vacuum cleaner comprising:
a motor being configured to be driven by direct current electricity and having an output power not less than 350 watts;
an alternating current to direct current (AC-to-DC) converting unit including
a first power supply configured to be electrically connected to a power socket to receive mains electricity, and configured to convert mains electricity into first DC electricity,
a DC stabilizer electrically connected to said first power supply and said motor, and configured to stabilize the first DC electricity received from said first power supply so as to output stabilized DC electricity with a current value that is maintained at a level not larger than 20 amperes to said motor,
a second power supply configured to be electrically connected to the power socket to receive mains electricity, and configured to convert mains electricity into second DC electricity, and
a rechargeable battery electrically connected to said second power supply and said motor, and configured to be charged by the second DC electricity received from said second power supply;
an operating unit including a switch for turning on said vacuum cleaner; and
a control unit electrically connected to said first power supply, said second power supply and said switch,
wherein, when said switch is in a conductive state and said control unit detects that the power socket provides ma ins electricity to said first and second power supplies, said vacuum cleaner operates in an external power supply mode, in which said control unit activates said first power supply to convert mains electricity into the first DC electricity so that said DC stabilizer outputs the stabilized DC electricity to said motor, and to activate said second power supply to convert mains electricity into the second DC electricity so that said rechargeable battery is charged by the second DC electricity.

2. The vacuum cleaner as claimed in claim 1, wherein, when said switch is in the conductive state and said control unit detects that no mains electricity is provided to said first and second power supplies, said vacuum cleaner operates in a battery-powered mode, in which said control unit controls said rechargeable battery to provide electricity to said motor.

3. The vacuum cleaner as claimed in claim 1, wherein, when said vacuum cleaner operates in the external power supply mode, said control unit deactivates said second power supply for a predetermined time period and activates said second power supply to convert mains electricity into the second DC electricity for charging said rechargeable battery upon elapsing of the predetermined time period.

4. The vacuum cleaner as claimed in claim 1, wherein, when said switch is in a non-conductive state and said control unit detects that the power socket provides mains electricity to at least said second power supply, said vacuum cleaner operates in a battery-charging mode, in which said control unit activates said second power supply to convert mains electricity into the second DC electricity for charging of said rechargeable battery.

5. The vacuum cleaner as claimed in claim 4, wherein, when said vacuum cleaner operates in the battery-charging mode, said control unit deactivates said second power supply for a predetermined time period and activates said second power supply to convert mains electricity into the second DC electricity for charging said rechargeable battery upon elapsing of the predetermined time period.

6. The vacuum cleaner as claimed in claim 1, wherein said first power supply is configured to output the first DC electricity with a voltage value of 24 volts, and said second power supply is configured to output the second DC electricity with a voltage value ranging from 27 volts to 28 volts and a current value of 3 amperes.

7. The vacuum cleaner as claimed in claim 1, further comprising a housing containing said motor therein, and a tube corresponding in position to said motor for vacuuming up dust.
